(19) United States
(12) Patent Application Publication
(10) Pub. No.: US 2024/0323757 A1
(43) Pub. Date: Sep. 26, 2024

(54) COMMUNICATION SYSTEM, RELAY DEVICE, AND RELAY METHOD

(71) Applicant: NEC CORPORATION, Tokyo (JP)

(72) Inventors: Kosei KOBAYASHI, Tokyo (JP); Hiroaki AMINAKA, Tokyo (JP); Motoharu OHTAKE, Tokyo (JP); Masaaki OOTAKE, Tokyo (JP); Masaru YANAI, Tokyo (JP); Kei YANAGISAWA, Tokyo (JP)

(73) Assignee: NEC CORPORATION, Minato-ku, Tokyo (JP)

(21) Appl. No.: 18/275,135

(22) PCT Filed: Feb. 5, 2021
(86) PCT No.: PCT/JP2021/004326

§ 371 Date: Jul. 31, 2023

(51) Int. Cl. H04W 28/06; H04W 28/02

(52) U.S. Cl. CPC H04W 28/06; H04W 28/0231

(57) ABSTRACT

To transmit, to a terminal, communication data corresponding to the characteristics of a network to which the terminal is connected while lightening the terminal-side processing load, a relay device comprises a reception unit configured to receive communication data addressed to a terminal from a communication device, at least one memory configured to store instructions; and at least one processor configured to execute the instructions to determine a compression parameter for the communication data on the basis of the characteristics of the network used for communication with the terminal, and a transmission unit configured to transmit the communication data compressed using the compression parameter to the terminal.

### TECHNICAL FIELD

The present invention relates to a communication system, a relay device, and a relay method that are capable of transmitting communication data according to a characteristic of a network.

### BACKGROUND ART

In recent years, video data having higher image quality than a conventionally used high definition (HD) resolution and being compatible with a 4K resolution have been used. In particular, a communication terminal being connectable to a 5th generation (5G) network can transmit and receive videos of both an HD resolution and a 4K resolution due to a characteristic of high-speed and large-capacity network of the 5G network.

PTL 1 discloses a terminal being capable of switching image quality and a route, and downloading a movie segment. PTL 2 discloses a relay server that converts quality of a video according to a quality parameter determined in a terminal, and transmits the video after the conversion to the terminal.

### CITATION LIST

### Patent Literature

PTL 1: Japanese Unexamined Patent Application Publication No. 2020-136906
PTL 2: Japanese Unexamined Patent Application Publication No. 2016-178356

### SUMMARY OF INVENTION

### Technical Problem

For example, in a terminal that is not able to be connected to a 5G network but is connectable to another network such as a long term evolution (LTE) network, it may be possible to receive a video with an HD resolution, but it may be difficult to receive a video with a 4K resolution, due to restriction on a network band.

Regarding communication data such as an image, a sound, and a video, there is such a correlation that a communication data amount increases as quality is heightened, but, as described above, quality of communication data that a terminal can appropriately receive is determined according to a characteristic of a network to which the terminal is connectable. Thus, it is necessary to transmit, to a terminal, communication data of quality according to a network to which the terminal is connected.

However, as in PTL 2, in a method of determining a quality parameter on a terminal (reception terminal) side that receives communication data, dedicated processing on the reception terminal side during quality parameter determination is essential, and there is a problem that it is difficult to apply the method to a terminal that does not support the dedicated processing.

The present invention has been made in view of the problems described above, and an object thereof is to provide a communication system, a relay device, and a relay method that are capable of transmitting, to a terminal, communication data according to a characteristic of a network to which the terminal is connected, while lightening a processing load on a terminal side.

### Solution to Problem

A relay device according to the present invention includes:
a reception means for receiving, from a communication device, communication data destined for a terminal;
a determination means for determining a compression parameter for the communication data, based on a characteristic of a network to be used for communication with the terminal; and
a transmission means for transmitting, to the terminal, the communication data compressed by use of the determined compression parameter.

Further, a communication system according to the present invention includes:
the relay device described above;
the communication device described above; and
the terminal described above.

Further, a relay method according to the present invention includes:
receiving, from a communication device, communication data destined for a terminal;
determining a compression parameter for the communication data, based on a characteristic of a network to be used for communication with the terminal; and
transmitting, to the terminal, the communication data generated by use of the determined compression parameter.

### Advantageous Effects of Invention

According to the present invention, it is possible to provide a communication system, a relay device, and a relay method that are capable of transmitting communication data according to a characteristic of a network to which a terminal is connected, while lightening a processing load on a terminal side.

### BRIEF DESCRIPTION OF DRAWINGS

FIG. 1 is a block diagram illustrating a configuration example of a communication system according to each of first and second example embodiments of the present invention.

FIG. 2 is a flowchart illustrating an operation example of the communication system according to the first example embodiment of the present invention.

FIG. 3 is a diagram for describing a modified example of the communication system according to each of the first and second example embodiments of the present invention.

FIG. 4 is a flowchart illustrating an operation in a modified example of the communication system according to the first example embodiment of the present invention.

FIG. 5 is a flowchart illustrating an operation example of the communication system according to the second example embodiment of the present invention.

FIG. 6 is a flowchart illustrating an operation in a modified example of the communication system according to the second example embodiment of the present invention.

FIG. 7 is a block diagram illustrating a configuration example of a relay device according to a third example embodiment of the present invention.

FIG. 8 is a flowchart illustrating an operation example of the relay device according to the third example embodiment of the present invention.

### EXAMPLE EMBODIMENT

### First Example Embodiment

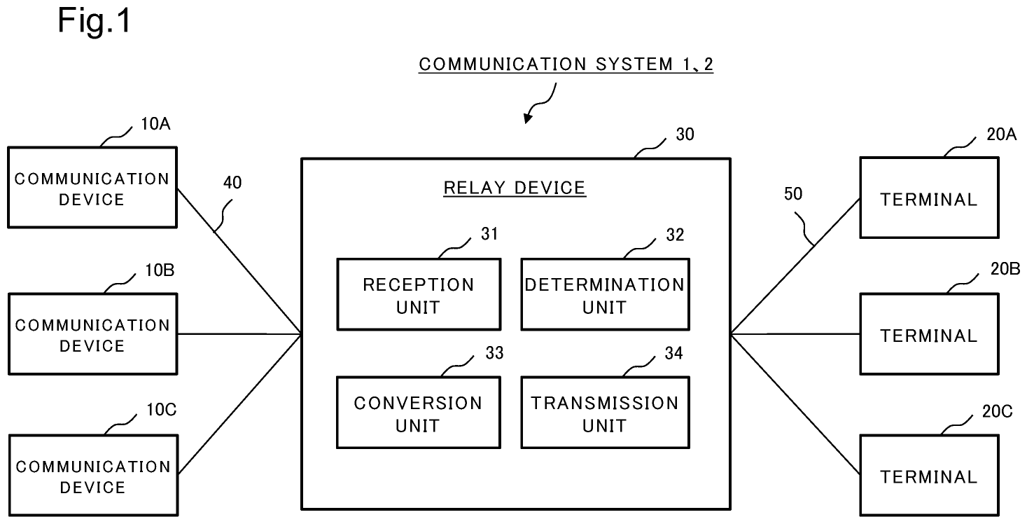

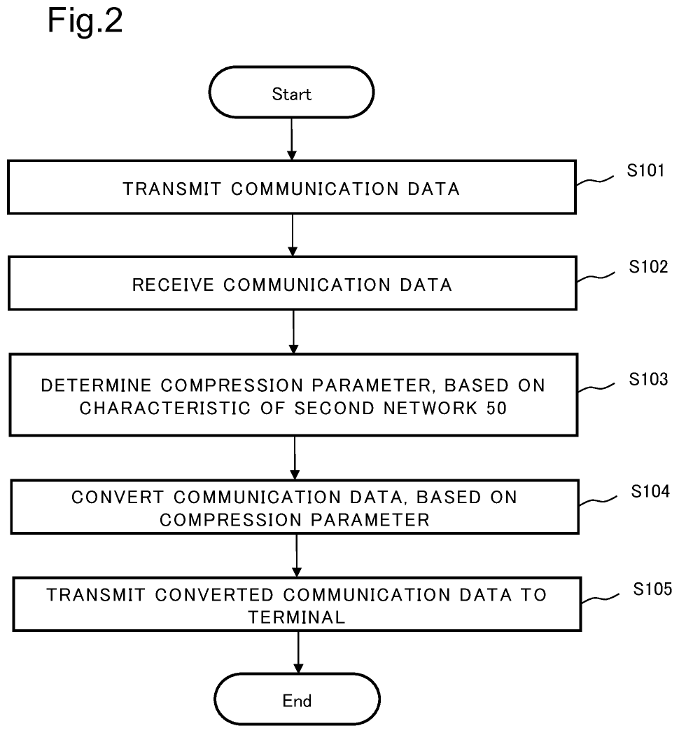

A communication system 1 according to the first example embodiment is described based on FIGS. 1 and 2. FIG. 1 is a block diagram illustrating a configuration example of the communication system 1. FIG. 2 is a flowchart illustrating an operation example of the communication system 1. As illustrated in FIG. 1, the communication system 1 includes communication devices 10A, 10B, and 10C, terminals 20A, 20B, and 20C, a relay device 30, a first network 40, and a second network 50.

Note that, when there is no need to distinguish between the communication devices 10A, 10B, and 10C, each of the communication devices 10A, 10B, and 10C is referred to as a communication device 10. When there is no need to distinguish between the terminals 20A, 20B, and 20C, each of the terminals 20A, 20B, and 20C is referred to as a terminal 20. The communication system 1 includes a plurality of communication devices 10 in FIG. 1, but may include one communication device 10. The communication system 1 includes a plurality of terminals 20 in FIG. 1, but may include one terminal 20.

The communication device 10 transmits communication data to the relay device 30. The communication device 10 is, for example, a communicable device such as a server, a PC, and a smartphone. The communication device 10 is connected to the relay device 30 via the first network 40. The communication device 10 transmits communication data to the terminal 20 via the first network 40, the relay device 30, and the second network 50. Communication data are, for example, data including at least one of an image, a sound, and a video. The first network may be a wired line, or may be a wireless line. Communication data to be transmitted by the communication device may be destined for one terminal 20, or may be destined for a group acquired by grouping a plurality of terminals 20.

The terminal 20 is a device to be a destination of communication data to be transmitted from the communication device 10. The terminal 20 is, for example, a communicable device such as a server, a PC, and a smartphone. The terminal 20 is connected to the relay device 30 via the second network 50. The terminal 20 may receive communication data from the communication device 10, and output the received communication data to a display, speaker, or the like.

As illustrated in FIG. 1, the relay device 30 includes a reception unit 31, a determination unit 32, a conversion unit 33, and a transmission unit 34. Note that, each of the reception unit 31, the determination unit 32, the conversion unit 33, and the transmission unit 34 is associated with each of a reception means, a determination means, a conversion means, and a transmission means. The relay device 30 relays, to the terminal 20, communication data received from the communication device 10. The relay device 30 is connected to the communication device 10 via the first network 40. The relay device 30 is connected to the terminal 20 via the second network 50.

The reception unit 31 receives communication data from the communication device 10. The determination unit 32 determines a compression parameter for communication data, based on a characteristic of the second network 50 used for communication between the relay device 30 and the terminal 20.

Herein, a characteristic of the second network 50 refers to a characteristic of a wireless network included in the second network 50. Specifically, a characteristic of the second network 50 is at least one of a type of a wireless network, a frequency bandwidth, a frequency band, a congestion degree, and wireless quality. A type of a network refers to, for example, a communication standard of a wireless network, and may include LTE, 5G, Wi-Fi, LPWA, and the like. A frequency bandwidth and a frequency band are, for example, a frequency bandwidth and a frequency band of a frequency resource used in a wireless access section in a wireless network. Wireless quality is, for example, reception power, a signal-to-interference-noise power ratio, or the like of a reference signal, a beacon signal, a pilot signal, or the like used in a wireless access section in a wireless network. A congestion degree refers to the communication traffic load in a wireless network, and includes, for example, a traffic volume, a wireless resource usage rate, a channel occupancy rate, and the like in a wireless access section in a wireless network. A congestion degree may be, for example, a processing load on a communication device (not illustrated) in a base station or the like included in a wireless network, a traffic volume in a wired line section included in a wireless network, or the like. The terminals 20A, 20B, and 20C may be connected to the second networks 50 being different from each other, and a characteristic of the second networks 50 in the respective terminals 20A, 20B, and 20C may be different from each other.

A compression parameter determined by the determination unit 32 is, for example, a compression parameter of an image, a sound, or a video, and indicates at least one of a compression ratio, a bit rate, the number of quantization bits, a sampling rate, a frame rate, a resolution, and a compression protocol. Herein, a compression protocol indicates, for example, a movie compression standard such as H.264 or H. 265 as to a video, an image compression standard such as JPEG, GIF, PNG, TIFF, or BMP as to an image, and an audio compression standard such as MPEG-1 audio layer-3 (MP3), advanced audio coding (AAC), or WAV as to a sound.

For example, the determination unit 32 may manage a transmission speed expected according to a type of the second network 50 to which the terminal 20 is connected and the type of each network, and determine a compression parameter for communication data received by the receiver 31, in such a way that a transmission speed becomes equal to or less than the expected transmission speed. As one example, the determination unit 32 manages that the terminal 20A is connected to W-CDMA, the terminal 20B is connected to LTE, and the terminal 20C is connected to 5G, and manages that communication at 500 kbps is possible in W-CDMA, communication at 1 Mbps is possible in LTE, and communication at 10 Mbps is possible in 5G. In this case, the determination unit 32 determines a compression parameter in such a way that the compression parameter becomes equal to or less than 500 kbps when communication data received by the reception unit 31 are transmitted to the terminal 20A, equal to or less than 1 Mbps when communication data received by the reception unit 31 are transmitted to the terminal 20B, and equal to or less than 10 Mbps when communication data received by the reception unit 31 are transmitted to the terminal 20C. For example, when communication data are a video, a transmission speed of communication data can be controlled by use of one or more compression parameters of a bit rate indicating a transmission data amount per unit time, a frame rate indicating the number of video frames per unit time, a resolution indicating the number of pixels per image, the number of quantization bits indicating an information amount per pixel, and a compression protocol. In this instance, the determination unit 32 can use a relationship that a communication data amount becomes large as each of a bit rate, a frame rate, a resolution, and the number of quantization bits heightens.

As another example, the determination unit 32 manages that the terminal 20A is connected to W-CDMA, the terminal 20B is connected to LTE, and the terminal 20C is connected to 5G, and manages classification of a communication speed in such a way as a communication speed “low” in W-CDMA, a communication speed “medium” in LTE, and “high” in 5G. In this case, when transmitting communication data received by the reception unit 31 to the terminal 20A, the determination unit 32 may determine a lower bit rate, a lower frame rate, a lower resolution, or a lower number of quantization bits, as compared with transmission to the terminal 20B.

Similarly, regarding the second network 50 to which the terminal 20 is connected, the determination unit 32 may manage a frequency bandwidth of a wireless network included in the network, and determine a compression parameter in such a way that a communication data amount becomes small as a frequency bandwidth is narrower. The determination unit 32 may utilize a relationship between a frequency band, and a frequency bandwidth and a communication standard used in the frequency band, manage a frequency band instead of the frequency bandwidth, derive, from a frequency band, a frequency bandwidth and a communication standard to be utilized in the frequency band, and determine a compression parameter in such a way as to acquire a communication data amount suitable for the frequency bandwidth and the communication standard. The determination unit 32 may determine a compression parameter in such a way that a communication data amount becomes small as a congestion degree of the second network 50 is higher, based on a communication characteristic that a transmission speed becomes slow as a communication traffic load is higher. Regarding the second network 50 to which the terminal 20 is connected, the determination unit 32 may determine a compression parameter in such a way that a communication data amount becomes smaller as wireless quality of a wireless network included in the network is lower. This is because a wireless communication standard such as LTE and 5G adjusts a modulation scheme and a coding rate according to wireless quality, and has such a characteristic that a transmission rate becomes low as wireless quality is lower.

Note that, the determination unit 32 may preliminarily hold information for each of the terminals 20, as to information relating to a type of a wireless network to which the terminal 20 is connected, a frequency bandwidth, and a frequency band. For example, IP address information of the terminal 20, and information relating to a type of a wireless network to which the terminal 20 is connected, a frequency bandwidth, and a frequency band may be held in association with each other. The determination unit 32 may acquire, from the second network 50, information relating to a type of a wireless network to which the terminal 20 is connected, a frequency bandwidth, a frequency band, a congestion degree, and wireless quality. The determination unit 32 may acquire, based on an information notification from the terminal 20, information relating to a type of a wireless network to which the terminal 20 is connected, a frequency bandwidth, a frequency band, a congestion degree, and wireless quality. For example, the terminal 20 may periodically transmit, to the relay device 30, information of at least one of a type of a wireless network, a frequency bandwidth, a frequency band, a congestion degree, and wireless quality, or may transmit, to the relay device 30, information of at least one of a type of a wireless network, a frequency bandwidth, a frequency band, a congestion degree, and wireless quality when a change is made in information of at least one of a type of a wireless network, a frequency bandwidth, a frequency band, a congestion degree, and wireless quality. The terminal 20 may transmit an identifier of the terminal 20 such as an IP address, a user name, and a terminal name, along with information relating to a type of a wireless network, a frequency bandwidth, a frequency band, a congestion degree, and wireless quality.

The conversion unit 33 compresses the communication data received by the reception unit 31, by use of a compression parameter determined by the determination unit 32. For example, when the reception unit 31 receives an image, a sound, or a video as communication data, the conversion unit 33 compresses the communication data received by the reception unit 31 for each of the terminals 20, by use of a compression parameter determined by the determination unit 32. Note that, such conversion of compression is also called a transcoding technique. The transmission unit 34 transmits the communication data compressed by the conversion unit 33, to the terminal 20 via the second network 50.

One example of the configuration of the communication system 1 has been described above. Next, an operation example of the communication system 1 is described by use of FIG. 2.

The communication device 10 transmits communication data to the relay device 30 (S101). The reception unit 31 of the relay device 30 receives the communication data (S102).

The determination unit 32 determines a compression parameter, based on a characteristic of the second network 50 (S103). Specifically, the determination unit 32 determines, based on a characteristic of the second network 50 between the relay device 30 and the terminal 20A, a compression parameter for communication data to be transmitted to the terminal 20A. Similarly, the determination unit 32 determines each of compression parameters for communication data to be transmitted to the terminals 20B and 20C. In this instance, a compression parameter for each piece of communication data may be the same or different.

The conversion unit 33 converts the communication data, based on the compression parameter determined by the determination unit 32 (S104). Specifically, when the communication data are an image, a sound, or a video, the communication data to be transmitted to the terminals 20A, 20B, and 20C are compressed. The transmission unit 34 transmits the converted communication data to the terminal 20 (S105).

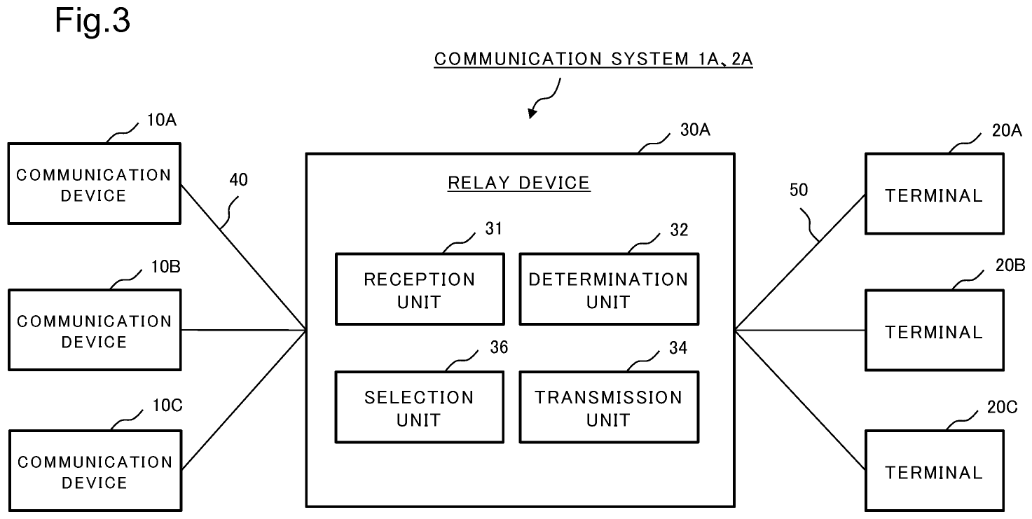

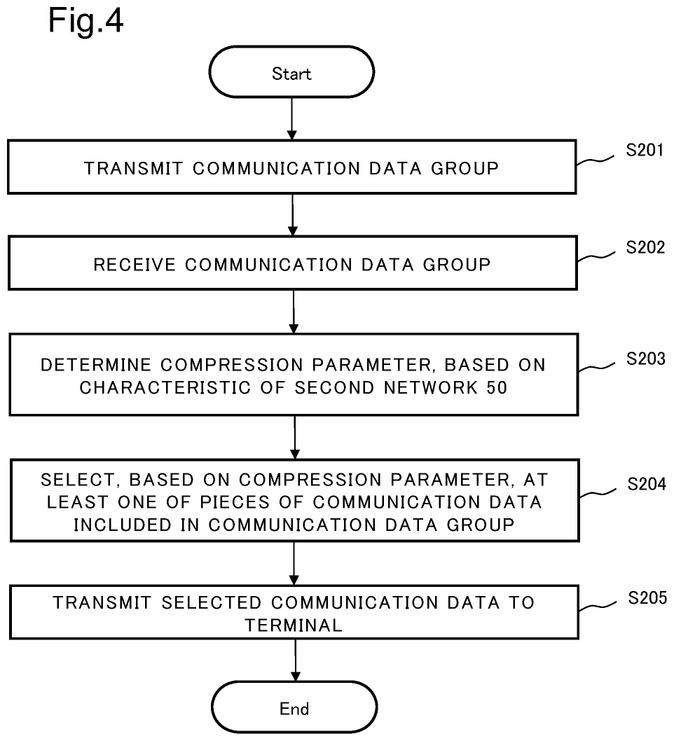

The operation of the communication system 1 has been described above. Next, a communication system 1A is described based on FIGS. 3 and 4. The communication system 1A includes a configuration similar to that of the communication system 1. The communication system 1A is different from the communication system 1 in including a relay device 30A instead of the relay device 30. The relay device 30A is different from the relay device 30 in including a selection unit 36 instead of the conversion unit 33. Note that, the selection unit 36 is associated with a selection means.

In the communication system 1A, the communication device 10 transmits, to the relay device 30A, a communication data group including a plurality of pieces of communication data converted from the same data by use of different compression parameters. For example, in the communication system 1A, the communication device 10 transmits, to the relay device 30A, a communication data group including first communication data acquired by compressing one piece of video data at a fixed bit rate of 1 Mbps, and second communication data acquired by compressing the same video data at a fixed bit rate of 10 Mbps.

As described above, a communication data group is an aggregate of communication data acquired by converting the same data with different compression parameters. Communication data included in one communication data group are transmitted from mutually the same communication device 10, and destined for the same terminal 20. Note that, the terminal 20 to be a destination may be one terminal, or may be a plurality of terminals. A compression parameter herein is at least one of a compression ratio, a bit rate, the number of quantization bits, a sampling rate, a frame rate, a resolution, and a compression protocol, as described above.

The selection unit 36 selects, based on the compression parameter determined by the determination unit 32, communication data to be transmitted to the terminal 20, from among pieces of communication data included in the communication data group. As one example, when the terminal 20A is connected to LTE, the terminal 20B is connected to 5G, a transmission rate of 1 Mbps is expected in LTE, and a transmission rate of 10 Mbps is expected in 5G, the determination unit 32 determines, as a compression parameter (a bit rate of a video) for the terminal 20A, 1 Mbps being the same bit rate as an expected transmission speed, and determines, as a compression parameter (a bit rate of a video) for the terminal 20B, 10 Mbps being the same bit rate as an expected transmission speed. When the communication device 10 transmits, to the terminal 20A, a communication data group including first communication data acquired by compressing one piece of video data at a fixed bit rate of 1 Mbps, and second communication data acquired by compressing the same video data at a fixed bit rate of 10 Mbps, the selection unit 36 of the communication system 1A selects the first communication data as communication data to be transmitted to the terminal 20A. Similarly, when transmitting the communication data group to the terminal 20B, the selection unit 36 of the communication system 1A selects the second communication data as the communication data to be transmitted to the terminal 20B. Note that, while a case where a communication data group includes communication data having a bit rate matching the determined compression parameter (a bit rate of a video has been described in the example herein, the present invention is not limited thereto, and communication data having a bit rate being equal to or less than a bit rate acquired by the determined compression parameter may be selected. Communication data having the highest bit rate may be selected from among pieces of communication data having a bit rate equal to or less than a bit rate acquired by the determined compression parameter.

Next, an operation example of the communication system 1A is described by use of FIG. 4.

The communication device 10 transmits a communication data group to the relay device 30A (S201). The reception unit 31 of the relay device 30A receives the communication data group (S202).

The determination unit 32 determines a compression parameter, based on a characteristic of the second network 50 (S203). Specifically, the determination unit 32 determines a compression parameter for communication data to be transmitted to the terminal 20A, based on a characteristic of the second network 50 between the relay device 30A and the terminal 20A. Similarly, the determination unit 32 determines each of compression parameters for communication data to be transmitted to the terminals 20B and 20C.

The selection unit 36 selects at least one piece of the communication data included in the communication data group, based on the compression parameter determined by the determination unit 32 (S204). The transmission unit 34 transmits the selected communication data to the terminal 20 (S205).

In this way, the relay devices 30 and 30A each includes a reception unit 31, a determination unit 32, and a transmission unit 34. The reception unit 31 receives, from the communication device 10, communication data destined for the terminal 20. The determination unit 32 determines a compression parameter for communication data, based on a characteristic of a network (the second network 50) used for communication with the terminal 20. The transmission unit 34 transmits, to the terminal 20, communication data compressed by use of the determined compression parameter.

As described above, in the communication systems 1 and 1A, the relay devices 30 and 30A perform determination of a compression parameter. Thus, there is no need to determine a compression parameter in the terminal 20 being a destination of communication data. As a result, the communication systems 1 and 1A can transmit, to the terminal 20, communication data according to a characteristic of the network (second network 50) to which the terminal 20 is connected, while lightening a processing load on the terminal 20.

In the communication system 1, the relay device 30 further includes the conversion unit 33 that converts communication data received from the communication device 10 by use of a determined compression parameter. Thus, the communication device 10 does not need to transmit communication data converted from the same data using a different compression parameter, and may transmit one piece of communication data, whether the terminal 20 to be a destination is one terminal or a plurality of the terminals. As a result, a traffic load in the first network 40 between the communication device 10 and the relay device 30 and a processing load on the communication device 10 can be lightened.

In the communication system 1A, the communication device 10 transmits, to the relay device 30A, a plurality of pieces of communication data converted from the same data by use of a different compression parameter. Further, the relay device 30A includes the selection unit 36 that selects communication data to be transmitted to the terminal 20 from among a plurality of pieces of communication data, based on the determined compression parameter. Thus, the relay device 30A does not need to perform compression of communication data. As a result, a processing load in the relay device 30A can be lightened.

Note that, a specific example has been shown by taking up a video as communication data in the above description, but the present invention is not limited thereto, and communication data may be an image or a sound. Even when communication data are an image or a sound, a communication data amount can be controlled by use of at least one of compression parameters of a compression ratio, a bit rate, the number of quantization bits, a sampling rate, a frame rate, a resolution, and a compression protocol, as in a case where communication data are a video. For example, when the communication device 10 transmits an image to the terminal 20 by use of an application of chat, email, or the like, the relay device 30 or 30A may determine a compression parameter for an image within the received e-mail or chat according to a characteristic of the second network 50 to which the terminal 20 is connected, replace the image in the e-mail or chat with an image compressed by the determined compression parameter, and then transmit the image to the terminal 20. As one example, the determination unit 32 may hold an image resolution suitable for a type of a wireless network. For example, the determination unit 32 holds an association relationship of super extended graphics array plus (SXGA+) in which a resolution is 1400×1050 pixels when a type of a wireless network is LTE, and ultra extended graphics array (UXGA) in which a resolution is 1600×1200 when a type of a wireless network is 5G, as an image resolution suitable for a type of a wireless network. In this case, when the reception unit 31 receives an image of quad ultra extended graphics array (QUXGA) in which a resolution is 3200×2400 pixels, the determination unit 32 converts the image resolution to SXGA+ when the image is transmitted to the terminal 20 connected to LTE, and converts the image resolution to UXGA when the image is transmitted to the terminal 20 connected to 5G.

### Second Example Embodiment

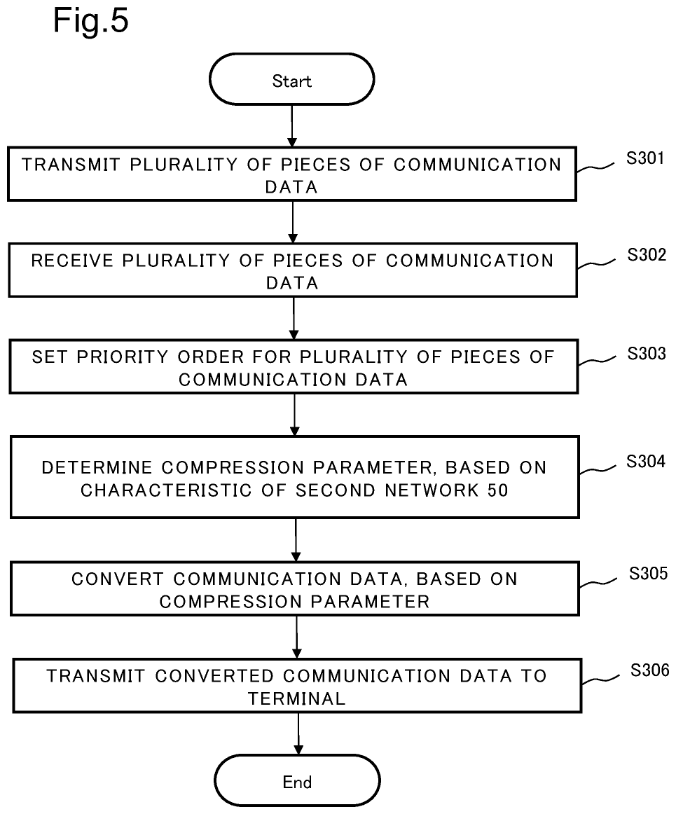

A communication system 2 according to a second example embodiment is described based on FIGS. 1 and 5. As illustrated in FIG. 1, the communication system 2 includes a configuration similar to that of a communication system 1. The communication system 2 is different from the communication system 1 in that a priority degree is set for each of a plurality of communication devices 10 and/or each of a plurality of terminals 20.

A priority degree is managed by, for example, a determination unit 32. For example, the determination unit 32 stores a first priority degree to be set for each of the terminals 20, based on at least one of a classification of the terminal 20, a user of the terminal 20, and a type of an application that processes communication data within the terminal 20. The classification of the terminal 20 is information indicating a use purpose of the terminal 20, for example, a general terminal, a business terminal, a command terminal, an IoT terminal, or the like. The user of the terminal 20 may be a contract classification such as a paid contract or a free contract, or an affiliated organization such as a company A or a company B. For example, a first priority degree set for the terminal 20 a classification of which is a business terminal is set higher than a first priority degree set for the terminal 20 a classification of which is a general terminal.

The determination unit 32 stores a second priority degree to be set for each of the communication devices 10, based on at least one of a classification of the communication device 10, a user of the communication device 10, and a type of an application that processes communication data to be transmitted to the relay device 30 in the communication device 10. For example, a second priority degree set for the communication device 10 a user of which is a public institution such as police or fire station is set higher than a second priority degree set for the communication device 10 a user of which is a private institution.

The determination unit 32 sets a priority order for communication data, based on at least one of the first priority degree and the second priority degree. For example, the determination unit 32 sets a priority order in descending order of a sum of a value being associated with the first priority degree and a value being associated with the second priority degree. Further, the determination unit 32 determines a compression parameter in descending order of priority orders, and the conversion unit 33 converts communication data in descending order of priority orders. In addition, the transmission unit 34 transmits communication data in descending order of priority orders. Note that, it is not always necessary to consider a priority order in all of the determination unit 32, the conversion unit 33, and the transmission unit 34 and a priority order may be considered in at least one of the determination unit 32, the conversion unit 33, and the transmission unit 34.

One example of the configuration of the communication system 2 has been described above. Next, an operation example of the communication system 2 is described by use of FIG. 5.

The communication device 10 transmits a plurality of pieces of communication data (S301). Herein, the plurality of pieces of communication data are pieces of data being different from each other in at least one of a content and a destination. For example, the communication device 10 transmits a plurality of pieces of communication data processed by different applications. For example, the communication device 10 transmits a plurality of pieces of communication data destined for the terminals 20 being different from each other. Note that, although it has been described above that one communication device 10 transmits a plurality of pieces of communication data in the processing of S301, a plurality of the communication devices 10 may transmit one piece or a plurality of pieces of communication data to a relay device 30.

A reception unit 31 of the relay device 30 receives a plurality of pieces of communication data (S302). The determination unit 32 sets a priority order for a plurality of pieces of communication data (S303). Specifically, the determination unit 32 sets a priority order for a plurality of pieces of communication data, based on a first priority degree set for the terminal 20 to be a destination of a plurality of the received communication data, and a second priority degree set for the communication device 10 being a transmission source of the communication data.

The determination unit 32 determines, based on a characteristic of a second network 50, a compression parameter for the communication data received by the reception unit 31 (S304). In this instance, the determination unit 32 determines a compression parameter for each piece of communication data.

The conversion unit 33 converts a plurality of pieces of communication data, based on the compression parameter determined by the determination unit 32 (S305). Specifically, communication data to be transmitted to the terminals 20A, 20B, and 20C are compressed by use of the determined compression parameter. The transmission unit 34 transmits the converted communication data to the terminal 20 (S306). In the processing of S304 to S306, the determination unit 32, the conversion unit 33, and the transmission unit 34 process communication data with a high priority order, prior to communication data with a low priority order.

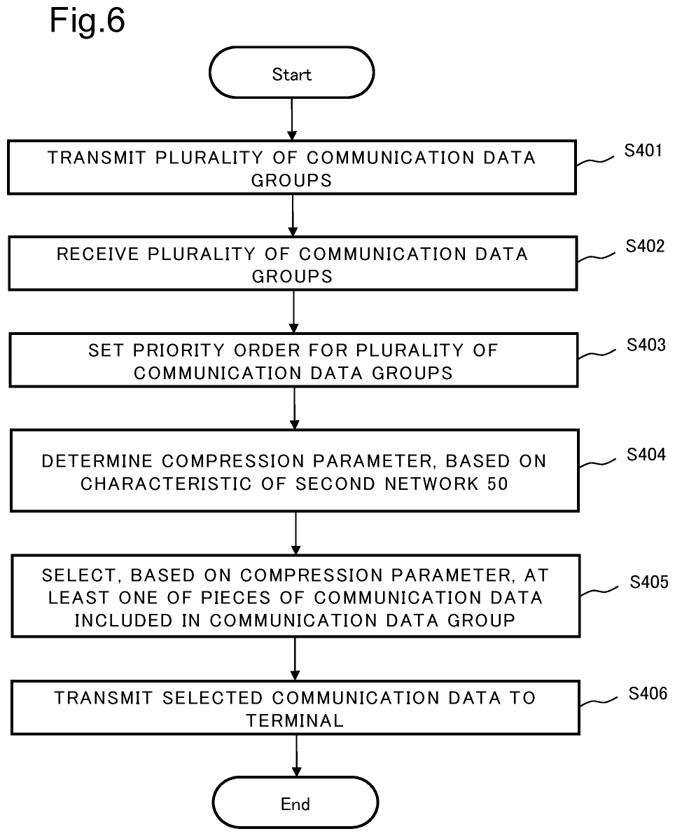

The communication system 2 has been described above. Next, a communication system 2A according to a modified example of the second example embodiment is described based on FIGS. 3 and 6. As illustrated in FIG. 3, the communication system 2A includes a configuration similar to that of the communication system 2. The communication system 2A is different from the communication system 2 in including a relay device 30A instead of the relay device 30, similarly to the communication system 1A.

Since the relay device 30A has been described in the description of the communication system 1A, description is omitted. In the communication system 2A, similarly to the communication system 2, the determination unit 32 sets a priority order for communication data, based on at least one of a first priority degree and a second priority degree.

An operation example of the communication system 2A is described by use of FIG. 6.

The communication device 10 transmits a plurality of communication data groups (S401). Herein, the plurality of communication data groups are data groups being different from each other in at least one of a content and a destination. For example, the communication device 10 transmits a plurality of communication data groups processed by applications being different from each other. For example, the communication device 10 transmits a plurality of communication data groups destined for the terminals 20 groups being different from each other. Note that, although it has been described above that the one communication device 10 transmits a plurality of communication data groups in the processing of S401, a plurality of the communication devices 10 may transmit one piece or a plurality of pieces of communication data to the relay device 30A.

The reception unit 31 of the relay device 30A receives a plurality of communication data groups (S402). The determination unit 32 sets a priority order for a plurality of communication data groups (S403). Specifically, the determination unit 32 sets a priority order for the plurality of communication data groups, based on a first priority degree set for the terminal 20 to be a destination of the communication data included in a plurality of the received communication data groups, and a second priority degree set for the communication device 10 being a transmission source of the communication data group.

The determination unit 32 determines a compression parameter, based on a characteristic of the second network 50 (S404). In this instance, the determination unit 32 determines a compression parameter for each communication data group.

The selection unit 36 selects at least one of the communication data included in the communication data group, based on the compression parameter determined by the determination unit 32 (S405). The transmission unit 34 transmits the selected communication data to the terminal 20 (S406). In the processing of S404 to S406, the determination unit 32, the conversion unit 33, and the transmission unit 34 process communication data with a high priority order, prior to communication data with a low priority order. Note that, a priority order may be considered in at least one piece of the processing of the determination unit 32, the conversion unit 33, and the transmission unit 34.

As described above, in the communication systems 2 and 2A, the relay devices 30 and 30A process, by priority, communication data or a communication data group with a high priority order. Thus, the communication device 10 can transmit communication data with a high priority degree to the terminal 20 in preference to another piece of data.

Similarly to the communication systems 1 and 1A, the communication systems 2 and 2A each include the reception unit 31, the determination unit 32, and the transmission unit 34. Thus, similarly to the communication systems 1 and 1A, the communication systems 2 and 2A can transmit, to the terminal 20, communication data according to a characteristic of a network (the second network 50) to which the terminal 20 is connected, while lightening a processing load on the terminal 20.

### Third Example Embodiment

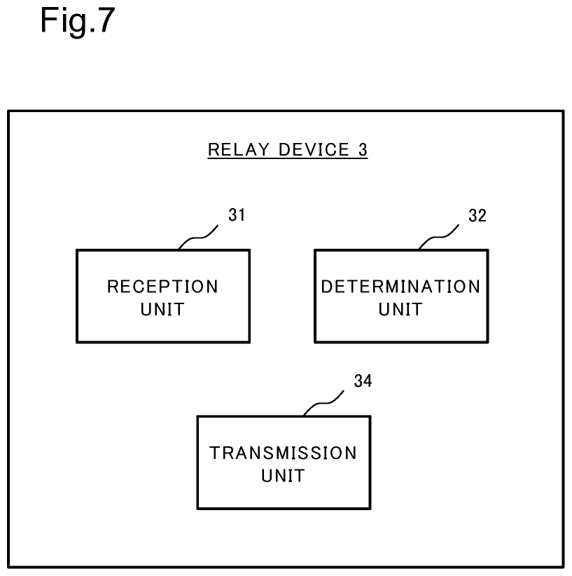

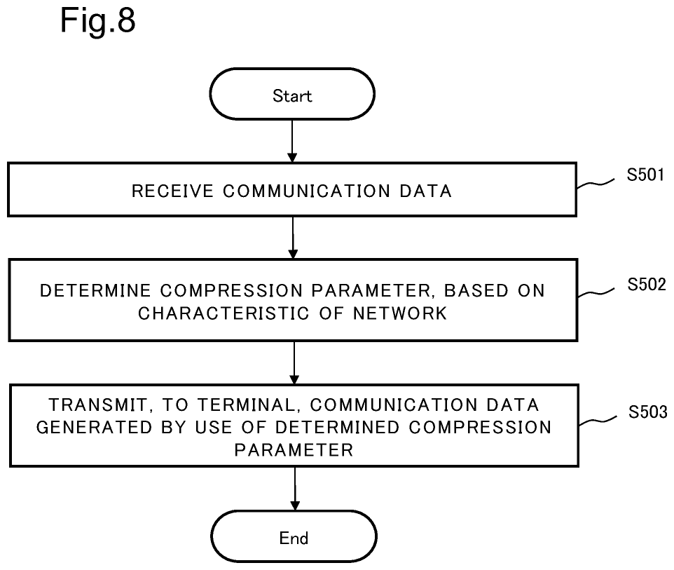

A relay device 3 according to a third example embodiment is described based on FIGS. 7 and 8. As illustrated in FIG. 7, the relay device 3 includes a reception unit 31, a determination unit 32, and a transmission unit 34. The relay device 3 may further include a component, a function, and a connection relationship similar to those of the relay device 30 in each of the communication systems 1 and 2 or the relay device 30A in each of the communication systems 1A and 2A described above.

The reception unit 31 receives communication data transmitted from a non-illustrated communication device. The reception unit 31 may include a function and a connection relationship similar to those of the reception unit 31 in each of the communication systems 1, 1A, 2, and 2A described above.

The determination unit 32 determines a compression parameter of communication data, based on a characteristic of a network used for communication between the relay device 3 and a non-illustrated terminal. The decision unit 32 may include a function and a connection relationship similar to those of the decision units 32 in each of the communication systems 1, 1A, 2, and 2A described above.

The transmission unit 34 transmits, to the terminal, communication data compressed by use of the compression parameter determined by the determination unit 32. The transmission unit 34 may include a function and a connection relationship similar to those of the transmission unit 34 in each of the communication systems 1, 1A, 2, 2A described above.

Next, an operation of the relay device 3 is described based on FIG. 8

The reception unit 31 receives communication data (S501). The determination unit 32 determines a compression parameter for communication data, based on a characteristic of a network used for communication between the relay device 3 and a terminal (S502). The transmission unit 34 transmits, to the terminal, communication data compressed by use of the determined compression parameter (S503).

As described above, the relay device 3 performs determination of a compression parameter and compression of communication data using the compression parameter. Thus, there is no need to perform determination of a compression parameter in the terminal being a destination of the communication data. As a result, the relay device 3 can transmit, to a terminal, communication data according to a characteristic of a network to which the terminal is connected, while lightening a processing load on the terminal.

Some or all of the above-described example embodiments can also be described as, but are not limited to, the following supplementary notes.

### (Supplementary Note 1)

A relay device including:
a reception means for receiving, from a communication device, communication data destined for a terminal;
a determination means for determining a compression parameter for the communication data, based on a characteristic of a network to be used for communication with the terminal; and
a transmission means for transmitting, to the terminal, the communication data compressed by use of the determined compression parameter.

### (Supplementary Note 2)

The relay device according to supplementary note 1, further including a conversion means for compressing the communication data received from the communication device, by use of the determined compression parameter.

### (Supplementary Note 3)

The relay device according to supplementary note 1, further including a selection means for selecting communication data to be transmitted to the terminal from among a plurality of pieces of the communication data, based on the determined compression parameter, wherein
the reception means receives, from the communication device, each of a plurality of pieces of the communication data compressed from same data by use of the different compression parameters; and
the transmission means transmits, to the terminal, communication data selected by the selection means, among a plurality of pieces of the communication data received by the reception means.

### (Supplementary Note 4)

The relay device according to any one of supplementary notes 1 to 3, wherein
the communication data include at least one of an image, a sound, and a video.

### (Supplementary Note 5)

The relay device according to supplementary note 4, wherein
the compression parameter is at least any of a compression ratio, a bit rate, quantization precision, a sampling rate, a resolution, and a compression protocol.

### (Supplementary Note 6)

The relay device according to any one of supplementary notes 1 to 5, wherein
the network includes a wireless network, and a characteristic of the network is at least any of a type of the wireless network, a frequency bandwidth, a frequency band, a congestion degree, and wireless quality.

### (Supplementary Note 7)

The relay device according to supplementary note 6, wherein a characteristic of the network is acquired by an information notification from the terminal.

### (Supplementary Note 8)

The relay device according to any one of supplementary notes 1 to 7, wherein
destinations of the communication data transmitted by the communication device are a plurality of the terminals,
the determination means determines the compression parameter for each of the terminals, and
the transmission means transmits, to each of the associated terminals, each piece of the communication data compressed by use of the determined compression parameter.

### (Supplementary Note 9)

The relay device according to supplementary note 8, wherein the transmission means transmits the communication data compressed by use of the determined compression parameter, according to a first priority degree being set for each of the plurality of terminals.

### (Supplementary Note 10)

The relay device according to supplementary note 9, wherein the first priority degree is set based on at least one of a classification of the terminal, a user of the terminal, and a type of an application that processes the communication data within the terminal.

### (Supplementary Note 11)

The relay device according to any one of supplementary notes 1 to 10, wherein
the reception means receives, from a plurality of the communication devices, the communication data destined for the terminal, and
the transmission means transmits, to the terminal, the communication data compressed by use of the determined compression parameter, according to a second priority degree being set for each of a plurality of the communication devices.

### (Supplementary Note 12)

The relay device according to supplementary note 11, wherein
the second priority degree is set based on at least one of a classification of the communication device, a user of the communication device, and a type of an application that processes the communication data within the communication device.

### (Supplementary Note 13)

A communication system including:
the relay device according to any one of supplementary notes 1 to 12;
the communication device; and
the terminal.

### (Supplementary Note 14)

A relay method including:
receiving, from a communication device, communication data destined for a terminal;
determining a compression parameter for the communication data, based on a characteristic of a network to be used for communication with the terminal; and
transmitting, to the terminal, the communication data generated by use of the determined compression parameter.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 1A, 2, 2A Communication system
3 Relay device
10, 10A, 10B, 10C Communication device
20, 20A, 20B, 20C Terminal
30, 30A Relay device
31 Reception unit
32 Determination unit
33 Conversion unit
34 Transmission unit
36 Selection unit

What is claimed is:

1. A relay device comprising:
reception unit configured to receive, from a communication device, communication data destined for a terminal;
at least one memory configured to store instructions; and at least one processor configured to execute the instructions to determine a compression parameter for the communication data, based on a characteristic of a network to be used for communication with the terminal; and
transmission unit configured to transmit, to the terminal, the communication data compressed by use of the determined compression parameter.

2. The relay device according to claim 1, wherein the at least one processor compresses the communication data received from the communication device, by use of the determined compression parameter.

3. The relay device according to claim 1, wherein the at least one processor selects communication data to be transmitted to the terminal from among a plurality of pieces of the communication data, based on the determined compression parameter, wherein
the reception unit receives, from the communication device, each of a plurality of pieces of the communication data compressed from same data by use of the different compression parameters; and
the transmission unit transmits, to the terminal, communication data selected by the at least one processor, among a plurality of pieces of the communication data received by the reception unit.

4. The relay device according to claim 1, wherein
the communication data include at least one of an image, a sound, and a video.

5. The relay device according to claim 4, wherein
the compression parameter is at least any of a compression ratio, a bit rate, quantization precision, a sampling rate, a resolution, and a compression protocol.

6. The relay device according to claim 1, wherein
the network includes a wireless network, and a characteristic of the network is at least any of a type of the wireless network, a frequency bandwidth, a frequency band, a congestion degree, and wireless quality.

7. The relay device according to claim 6, wherein a characteristic of the network is acquired by an information notification from the terminal.

8. The relay device according to claim 1, wherein
destinations of the communication data transmitted by the communication device are a plurality of the terminals,
the at least one processor determines the compression parameter for each of the terminals, and
the transmission unit transmits to each of the associated terminals, each piece of the communication data compressed by use of the determined compression parameter.

9. The relay device according to claim 8, wherein the transmission unit transmits the communication data compressed by use of the determined compression parameter, according to a first priority degree being set for each of the plurality of terminals.

10. The relay device according to claim 9, wherein the first priority degree is set based on at least one of a classification of the terminal, a user of the terminal, and a type of an application that processes the communication data within the terminal.

11. The relay device according to claim 1, wherein
the reception unit receives, from each of a plurality of the communication devices, the communication data destined for the terminal, and
the transmission unit transmits, to the terminal, the communication data compressed by use of the determined compression parameter, according to a second priority degree being set for each of a plurality of the communication devices.

12. The relay device according to claim 11, wherein
the second priority degree is set based on at least one of a classification of the communication device, a user of the communication device, and a type of an application that processes the communication data within the communication device.

13. A communication system comprising:
the relay device according to claim 1,
the communication device; and
the terminal.

14. A relay method comprising:
receiving, from a communication device, communication data destined for a terminal;
determining a compression parameter for the communication data, based on a characteristic of a network to be used for communication with the terminal; and
transmitting, to the terminal, the communication data generated by use of the determined compression parameter.

15. The relay device according to claim 2, wherein
the communication data include at least one of an image, a sound, and a video.

16. The relay device according to claim 3, wherein
the communication data include at least one of an image, a sound, and a video.

17. The relay device according to claim 2, wherein
the network includes a wireless network, and a characteristic of the network is at least any of a type of the wireless network, a frequency bandwidth, a frequency band, a congestion degree, and wireless quality.

18. The relay device according to claim 3, wherein
the network includes a wireless network, and a characteristic of the network is at least any of a type of the wireless network, a frequency bandwidth, a frequency band, a congestion degree, and wireless quality.

19. The relay device according to claim 4, wherein
the network includes a wireless network, and a characteristic of the network is at least any of a type of the wireless network, a frequency bandwidth, a frequency band, a congestion degree, and wireless quality.

20. The relay device according to claim 2, wherein
the network includes a wireless network, and a characteristic of the network is at least any of a type of the wireless network, a frequency bandwidth, a frequency band, a congestion degree, and wireless quality.
